(19) United States
(12) Patent Application Publication
(10) Pub. No.: US 2002/0122008 A1
(43) Pub. Date: Sep. 5, 2002

(54) Antenna including integrated filter

(76) Inventors: Frank M. Caimi, Vero Beach, FL (US); Michael H. Thursby, Palm Bay, FL (US); Kerry L. Greer, Palm Bay, FL (US); Donald A. Innis, Melbourne, FL (US)

Correspondence Address: John L. DeAngelis, Jr.Esquire, Holland & Kinght LLP, Suite 201, 1499 S. Harbor City Blvd., Melbourne, FL, 32901, US

(21) Appl. No.: 10/066,937

(22) Filed: Feb. 4, 2002

Related U.S. Application Data
(60) Provisional application No. 60/266,245, filed on Feb. 2, 2001.

(51) Int. Cl. H01Q 11/12; H01Q 7/00

(52) U.S. Cl. 343/742; 343/748; 343/741

(57) ABSTRACT

An integrated antenna and filter. Integrating and collocating the antenna element and a signal filter eliminates the affects of interfering signals that are induced in the transmission line between the antenna and the receiver/transmitter. The use of fiber optic transmission line cable for connecting the receiver/transmitter and the antenna reduces spurious radio frequency emissions from the transmission line that can cause interference to other nearby receiver/transmitter systems and prevents spurious interfering signals from entering the transmission line.

This patent application claims the benefit of Provisional Patent Application Number 60/266,245 filed on Feb. 2, 2001.

### FIELD OF THE INVENTION

The present invention relates generally to antennas and more specifically to an antenna including an integrated filter.

### BACKGROUND OF THE INVENTION

Many radio frequency (RF) transmitting and receiving installations utilize a mast-based antenna or antennas, connected via a transmission line to ground-based receiving and transmitting components, which are typically housed in a shelter, enclosure or cabinet at the base of the antenna mast or tower. Antennas for several different wireless services or operating at different frequencies for the same wireless service, frequently share such an antenna mast. With the proliferation of wireless devices and the base station antennas to service them, and the attendant crowding of the RF spectrum, co-interference caused by spatially close wireless service antennas operating at adjacent or nearby spectral frequencies is an increasingly serious problem.

At mast sites, or any site where radio services are co-located, the conventional technique for reducing the interference is through the use of in-line filters providing any of the known filter functions, such as low pass, high pass, bandpass, band reject, notch, diplexer or duplex, and high-isolation transmission lines between the antenna and the receiver/transmitter. The transmission lines, which are by necessity expensive and bulky to achieve the required high-isolation properties, are designed to prevent the unintended reception of interfering signals from nearby transmitting antennas and nearby leaking transmission lines. The high-isolation lines are also designed to limit the outgoing RF leakage that may cause problems for adjacent transmission lines and receiving/transmitting equipment. The filters are typically co-located with the receiver/transmitter equipment or in-line, that is, within the transmission line. Certain of these filters are tunable under control of the receiver/transmitter such that as the receiver or transmitter is tuned, the appropriate frequency components are passed or blocked by the filter. Whether located in-line or with the receiver/transmitter, additional space is required to accommodate the filter components. For microcellular wireless telephone applications, space must be made available at the base of the tower, where it is at a premium. In-line filters require special cables and connectors to connect the filter into the transmission line. These connectors can become a source of interfering radiation for other nearby transmitting and receiving devices. Signal leakage is especially prevalent at the cable connectors and increases as the cable deteriorates due to water intrusion and other weathering effects. Also, the filters must be designed to match the impedance of the transmission line to which it is connected. The transmission lines themselves are also problematic as water leakage, physical damage (e.g., gouging or denting of the cable) or loose connectors between line segments can create impedance changes that affect the line's performance.

At an exemplary antenna tower, it is determined that the transmission line between the tower and the receiver/transmitter is particularly susceptible to interference from another antenna mounted on the tower and operating at a frequency f. To remedy this situation, a notch filter is installed in the transmission line. The installation requires opening the high-isolation transmission line and installing the notch filter, with a notch at f, to attenuate the troublesome signal. High isolation connectors are required for this installation, and upon completion, the system performance must be tested to determine if it remains acceptable. It is known that the installation of filters may disrupt and modify the transmission line characteristics and thus the performance of the entire system.

These filters are generally purchased from suppliers other than the antenna supplier and thus must be mechanically fitted to and electrically matched to the transmission line characteristics. Since the filters are installed during construction of the radio site or in the event of a problem as described above, after assembly of the antenna and the filter, certain performance tests are required to ensure that the elements are functioning properly.

Antennas employed in these wireless applications as mounted on towers and masts include any of the well known antenna types: half-wave dipoles, loops, horns, patches, parabolic dishes, etc. The antenna selected for any given application is dependent on the requirements of the system, as each antenna offers different operational characteristics, including: radiation pattern, efficiency, polarization, input impedance, radiation resistance, gain, directivity, etc.

Another type of antenna that can be used in these base stations is the meanderline-loaded antenna (MLA), which was developed to de-couple the conventional relationship between the antenna physical length and resonant frequency, and thus provides an electrically long but physically small antenna.

A typical meanderline-loaded antenna, also known as a variable impedance transmission line (VITL) antenna, is disclosed in U.S. Pat. No 5,790,080. The antenna consists of two vertical conductors and a horizontal conductor, with a gap separating each vertical conductor from the horizontal conductor. The antenna further comprises one or more meanderline variable impedance transmission lines bridging the gap between the vertical conductor and each horizontal conductor. Each meanderline coupler is a slow wave transmission line structure carrying a traveling wave at a velocity less than the free space velocity. Thus the effective electrical length of the slow wave structure is considerably greater than its actual physical length. The relationship between the physical length and the electrical length is given by

lₑ=(ε_{eff}^{0.5})×lₚ

where lₑ is the effective electrical length, lₚ is the actual physical length, and ε_{eff} is the dielectric constant (εᵣ) of the dielectric material containing the transmission line. Using such meanderline structures, smaller antenna elements can be employed to form an antenna having, for example, quarter-wavelength properties.

A schematic representation of a meanderline-loaded antenna 10 is shown in a perspective view in FIG. 1. Generally, the meanderline-loaded antenna 10 includes two vertical conductors 12, a horizontal conductor 14, and a ground plane 16. The vertical conductors 12 are physically separated from the horizontal conductor 14 by gaps 18, but are electrically connected to the horizontal conductor 14 by two meanderline couplers, (not shown) one for each of the two gaps 18, to thereby form an antenna structure capable of radiating and receiving RF (radio frequency) energy. The meanderline couplers electrically bridge the gaps 18 and, in one embodiment, have controllably adjustable lengths for changing the characteristics of the meanderline-loaded antenna 10. In one embodiment of the meanderline coupler, segments of the meanderline can be switched in or out of the circuit quickly and with negligible loss, to change the effective length of the meanderline couplers, thereby changing the effective antenna length and thus the antenna performance characteristics. The switching devices are located in high impedance sections of the meanderline couplers, minimizing the current through the switching devices, resulting in low dissipation losses in the switching device and maintaining high antenna efficiency.

Like all antennas, the performance of the meanderline-loaded antenna 10 is significantly affected by the input signal frequency (i.e., the signal to be transmitted by the antenna) or wavelength relative to the antenna effective electrical length (i.e., the sum of the meanderline coupler lengths plus the antenna element lengths). According to the antenna reciprocity theorem, the antenna operational parameters are also substantially affected by the received signal frequency. Two of the various modes in which the antenna can operate are discussed herein below.

FIG. 2 shows a perspective view of a meanderline coupler 20 constructed for use in conjunction with the meanderline-loaded antenna 10 of FIG. 1. Two meanderline couplers 20 are generally required for use with the meanderline-loaded antenna 10; one meanderline coupler 20 bridging each of the gaps 18 illustrated in FIG. 1. However, it is not necessary for the two meanderline couplers to have the same physical (or electrical) length. The meanderline coupler 20 of FIG. 2 is a slow wave meanderline element (or variable impedance transmission line) in the form of a folded transmission line 22 mounted on a substrate 24, which is in turn mounted on a plate 25. In one embodiment, the transmission line 22 is constructed from microstrip line. Sections 26 are mounted close to the substrate 24; sections 27 are spaced apart from the substrate 24. In one embodiment as shown, sections 28, connecting the sections 26 and 27, are mounted orthogonal to the substrate 24. The variation in height of the alternating sections 26 and 27 from the substrate 24 gives the sections 26 and 27 different impedance values with respect to the substrate 24. As shown in FIG. 2, each of the sections 27 is approximately the same distance above the substrate 24. However, those skilled in the art will recognize that this is not a requirement for the meanderline coupler 20. Instead, the various sections 27 can be located at differing distances above the substrate 24. Such modifications change the electrical characteristics of the coupler 20 from the embodiment employing uniform distances. As a result, the characteristics of the antenna employing the coupler 20 are also changed. The impedance presented by the meanderline coupler 20 can be changed by changing the material or thickness of the microstrip substrate or by changing the width of the sections 26, 27 or 28. In any case, the meanderline coupler 20 must present a controlled (but controllably variable if the embodiment so requires) impedance. The effective electrical length of the meanderline coupler 20 is also changed by changing these physical parameters.

The sections 26 are relatively close to the substrate 24 (and thus the plate 25) to create a lower characteristic impedance. The sections 27 are a controlled distance from the substrate 24, wherein the distance determines the characteristic impedance and frequency characteristics of the section 27 in conjunction with the other physical characteristics of the folded transmission line 22.

The meanderline coupler 20 includes terminating points 40 and 42 for connection to the elements of the meanderline-loaded antenna 10. Specifically, FIG. 3 illustrates two meanderline couplers 20, one affixed to each of the vertical conductors 12 such that the vertical conductor 12 serves as the plate 25 from FIG. 2, forming a meanderline-loaded antenna 50. One of the terminating points shown in FIG. 2, for instance the terminating point 40, is connected to the horizontal conductor 14 and the terminating point 42 is connected to the vertical conductor 12. The second of the two meanderline couplers 20 illustrated in FIG. 3 is configured in a similar manner.

The operating mode of the meanderline-loaded antenna 50 (see FIG. 3) depends upon the relationship between the operating frequency and the effective electrical length of the antenna, including the meanderline couplers 20. Thus the meanderline-loaded antenna 50, like all antennas, exhibits operational characteristics determined by the ratio between the effective electrical length and the transmit signal frequency in the transmitting mode or the received frequency in the receiving mode. Different operating frequencies will excite the antenna so that it exhibits different operational characteristics, including different antenna radiation patterns. For example, a long wire antenna may exhibit the characteristics of a quarter wavelength monopole at a first frequency and exhibit the characteristics of a full-wavelength dipole at a frequency of twice the first frequency.

Turning to FIGS. 4 and 5, there is shown the current distribution (FIG. 4) and the antenna electric field radiation pattern (FIG. 5) for the meanderline-loaded antenna 50 operating in a monopole or half wavelength mode as driven by an input signal source 44. That is, in this mode, at a frequency of between approximately 800 and 900 MHz, the effective electrical length of the meanderline couplers 20, the horizontal conductor 14 and the vertical conductors 12 is chosen such that the horizontal conductor 14 has a current null near the center and current maxima at each edge. As a result, a substantial amount of radiation is emitted from the vertical conductors 12, and little radiation is emitted from the horizontal conductor 14. The resulting field pattern has the familiar omnidirectional donut shape as shown in FIG. 5.

A second exemplary operational mode for the meanderline-loaded antenna 50 is illustrated in FIGS. 6 and 7. This mode is the so-called loop mode, operative when the ground plane 16 is electrically large compared to the effective length of the antenna. In this mode the current maximum occurs approximately at the center of the horizontal conductor 14 (see FIG. 6) resulting in an electric field radiation pattern as illustrated in FIG. 7. The antenna characteristics displayed in FIGS. 6 and 7 are based on an antenna of the same effective electrical length (including the length of the meanderline couplers 20) as the antenna depicted in FIGS. 4 and 5. Thus, at a frequency of approximately 800 to 900 MHz, the antenna displays the characteristics of FIGS. 4 and 5, and for a signal frequency of approximately 1.5 GHz, the same antenna displays the characteristics of FIGS. 6 and 7. By changing the antenna element electrical lengths, monopole and loop characteristics can be attained at other frequency pairs. Generally, the meanderline loaded antenna exhibits monopole-like characteristics at a first frequency and loop-like characteristics at a second frequency where there is a loose relationship between the two frequencies, however, the relationship is not necessarily a harmonic relationship. A meanderline-loaded antenna constructed according to FIG. 1 and as further described hereinbelow, exhibits both monopole and loop mode characteristics, while typically most prior art antennas operate in only a loop mode or in monopole mode. That is, if the antenna is in the form of a loop, then it exhibits a loop pattern only. If the antenna has a monopole geometry, then only a monopole pattern can be produced. In contrast, a meanderline-loaded antenna according to the teachings of the present invention exhibits both monopole and loop characteristics.

FIG. 8 depicts an array 100 comprising a plurality of meanderline-loaded antennas 10 fixedly attached to a cylinder 102 that serves as the ground plane with separate electrical conductors (not shown in FIG. 8) providing a signal path to each meanderline-loaded antenna 10. Advantageously, the meanderline-loaded antennas 10 are disposed in alternating horizontal and vertically configurations to produce alternating horizontally and vertically polarized signals. That is, the first row of meanderline-loaded antennas 10 are disposed horizontally to emit a horizontally polarized signal in the transmit mode and to most efficiently receive a horizontally-polarized signal in the receive mode. The meanderline antennas 10 in the second row are disposed vertically to emit or receive vertically polarized signals. Although only four rows of the meanderline-loaded antennas 10 are illustrated in FIG. 8, those skilled in the art recognize that additional parallel rows can be included in the antenna array 100 so as to provide additional gain, where the gain of the antenna array 100 comprises both the element factor and the array factor, as is well known in the art.

FIG. 9 illustrates an antenna array 110 including alternating horizontally oriented elements 112 and vertically oriented elements 114. The horizontally oriented elements 112 and the vertically oriented elements 114 comprise the meanderline-loaded antenna constructed as described above. As can be seen in FIG. 9, the horizontally oriented elements 112 are staggered above and below the circumferential element centerline from one consecutive row of horizontal elements to the next. Although consecutive vertical elements 114 are shown in a linear orientation around the circumference of the cylinder 102, they too can be staggered. Staggering of the elements provides improved array performance.

### SUMMARY OF THE INVENTION

The present invention eliminates the requirement for separate filter elements by integrating the filter elements with the antenna, in one embodiment, within the feed structure that services the elements of an antenna array. Thus with the integrated filter and antenna, fewer connectors having high isolation are required for interconnecting the receiver/transmitter to the antenna, as the in-line filters as taught by the prior art are eliminated. In the transmitting mode any spurious signals or intermodulation components induced by the amplifier or by faulty components in the transmission line will be attenuated by the integrated filter and will therefore not reach the antenna. For example, intermodulation products can be generated in the transmission line when an RF signal impinges upon a corroded transmission line junction that operates as a rectifier. Also, the filter is tunable under control of the receiver/transmitter to ensure that the appropriate frequencies are attenuated or passed as required based on the operational frequency and bandwidth of the system. In the receiving mode, the integrated filter will attenuate any undesirable received signals. Since the filter and antenna are integrated at the point of manufacture, no filter tuning is required in the filed at the time of installation. The antenna and filter assembly are also matched at the point of manufacture, thus eliminating the requirement for impedance testing and matching at the antenna site during the installation process. As further described below, other benefits can be achieved from the use of the filter in conjunction with a demodulator and/or power amplifier integrated with the antenna or with each element of an antenna array. This approach permits the use of fiber optic cables for reception and transmission of low level signals between the receiver/transmitter and the antenna.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures. The drawings are not necessarily to scale, emphasis instead being placed upon illustrating the principles of the invention.

FIG. 1 illustrates a meanderline loaded antenna;

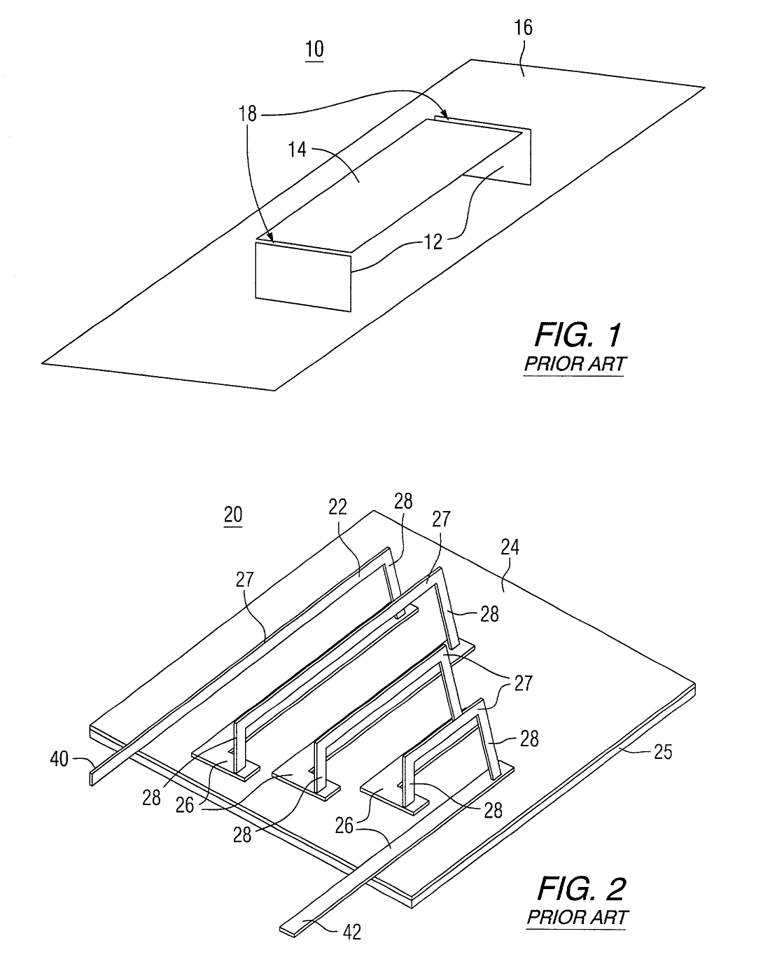

FIG. 2 illustrates a meanderline for use with the meanderline loaded antenna of FIG. 1;

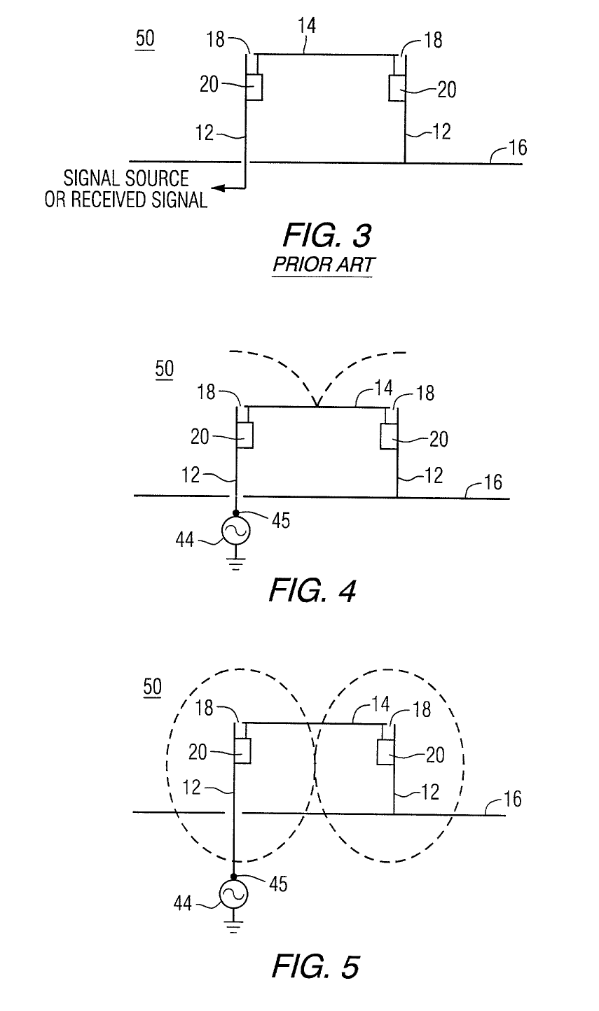

FIG. 3 illustrates another embodiment of a meanderline loaded antenna;

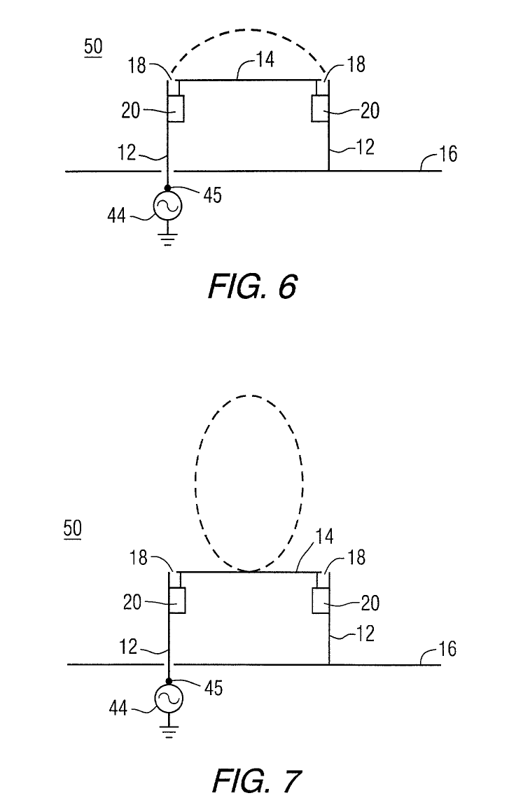

FIGS. 4, 5, 6 and 7 illustrate radiation patterns for the meanderline loaded antenna of FIG. 3;

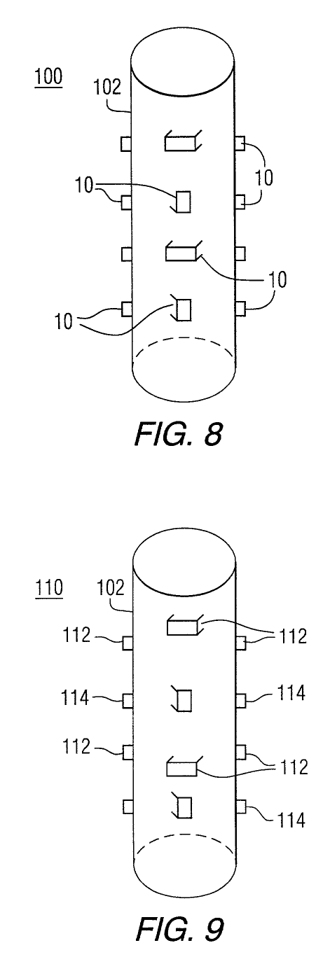

FIGS. 8 and 9 illustrate antenna arrays constructed using meanderline loaded antennas;

FIG. 10 is a block diagram of an integrated antenna and signal filter constructed according to the present invention;

FIGS. 11, 12 and 13 are block diagrams illustrating various embodiments of an integrated antenna and signal filter according to the teachings of the present invention.

### DETAILED DESCRIPTION OF THE INVENTION

Before describing in detail the particular integrated filter antenna in accordance with the present invention, it should be observed that the present invention resides primarily in a novel combination of hardware elements related to an integrated antenna and signal filter. Accordingly, the hardware elements have been represented by conventional elements in the drawings, showing only those specific details that are pertinent to the present invention, so as not to obscure the disclosure with structural details that will be readily apparent to those skilled in the art having the benefit of the description herein.

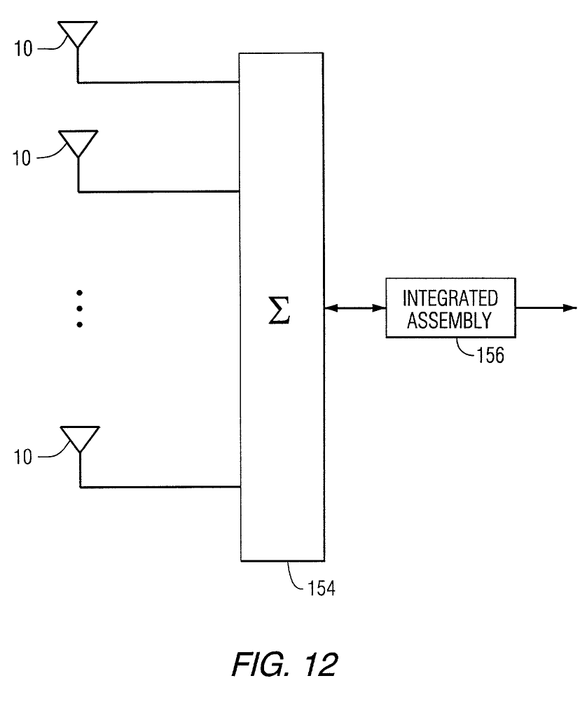

FIG. 10 illustrates a receiver/transmitter 130 connected to a serial arrangement of a power amplifier 131, a filter 132 and an antenna 134, comprising an integrated assembly 136. In another embodiment the power amplifier 131 may be excluded from the integrated assembly 136 and instead included within the transmitter of the receiver/transmitter 130. A transmission line 138 connects the receiver/transmitter 130 with the integrated assembly 136. Typically, there is also included a receive/transmit switch (not shown) for connecting the receiver to the integrated assembly 136 in the receiving mode and for connecting the transmitter to the integrated assembly 136 in the transmitting mode. As applied to an antenna array, an integrated assembly 136 is associated with each antenna element. According to the teachings of the present invention, the integrated assembly 136 is located at the top of a mast or tower (not shown in FIG. 10) and the receiver/transmitter 130 is located in an enclosure or shelter at the base of the tower. Further according to the teachings of the present invention, it is not required that the transmission line 138 have high isolation capabilities, since the filter 132 attenuates spurious emissions that can be induced in the transmission line 138 by nearby antennas and transmitters, for example antennas located on the same tower as the antenna 134. In addition, placement of the power amplifier 131 (or a plurality of such power amplifiers in an antenna array embodiment) at the top of the mast proximate the antenna 134, eliminates the signal power losses experienced along the prior art coaxial cables. When the teachings of the present invention are applied to an antenna array, it is generally less expensive to manufacture several power amplifiers of lower power (one for each array element) than a single power amplifier of larger power (serving all elements of the array).

In a preferred embodiment, the transmission line 138 is a fiber optic cable and therefore immune to radio frequency interference from nearby radiators, both intentional and unintentional radiators. When operative in the receiving mode, even when high isolation transmission lines are used according to the prior art, interference can be induced into the high isolation line (from in-line connectors for in-line filters, for example) and then presented to the receiver input stage. The use of a fiber optic transmission line eliminates this interference. Losses in the fiber optic cable are also lower than losses experienced in coaxial cable, which is the conventional material used for high-isolation transmission lines. Therefore the output power of the transmitter can be reduced in the transmitting mode and the signal power presented to the receiver is increased in the receiving mode. Further, the fiber optic cable does not leak radio frequency energy that can cause interference problems for nearby transmitting and receiving equipment. The RF electrical isolation afforded by the fiber optic cable also inherently provides the additional advantage of reducing disruptions caused by lightning strikes at the tower, especially if the system is battery-powered.

For those installations requiring the provision of electrical power from the base of the mast to power the power amplifier 131 (or the other elements of the integrated assembly 136), it can be provided as DC or AC power over a separate power cable from the base of the tower.

As applied to the antenna array embodiment discussed above, a separate fiber optic cable can service each element of the array and thereby provide signals of different amplitude and phase to each element to effect beam steering. Alternatively, signal multiplexing (for example, wavelength division multiplexing) can be used to drive each integrated assembly 136 from a single fiber optic cable. Both the filter 132 and the antenna 134 are tunable by a control signal on a control line 137 provided by the receiver/transmitter 130, to ensure filter operation at the correct frequencies and with the correct bandwidth. Thus the control signal adjusts the center frequency, bandwidth and the filter skirts (i.e., the slope of the lines defining the edges of the pass band or reject band for the filter). Also, since one terminal of the filter is connected directly to the antenna, no impedance matching is required for that terminal. The integrated filter and antenna can be sold as a standard product with only one transmission line impedance match required. Additional filter design flexibility is available once the limitation of matching both filter terminals to the transmission line impedance is obviated. Concurrent design of both the antenna and the filter allows the design of both to be optimized.

In another embodiment where the transmission line 138 is not fiber optic cable, the filter 132 attenuates out-of-band frequency components that may be induced in the transmission line 138, before they reach the antenna, from where they would be transmitted to receiving units. Such interfering signals can be induced in the transmission line 138 at connector joints, for example. It is known that even such out-of-band frequency components in the transmitted signal can degrade performance at the received in-band frequencies, due to the effect of these out-of-band signals on receiver sensitivity. For example, the filter 132 can comprise a band pass filter with the pass band defined by the transmitted signal spectrum, such that the out-of-band components are effectively attenuated. In another example, the filter 132 comprises the same band pass filter with the addition of a notch at the frequency of a nearby emitter, or at the frequency of an intermodulation product formed in the transmission line 138. With the filter 132 integrated with the antenna 134, the transmission line 138 is not required to have high isolation capabilities as the filter 132 will attenuate the out of band signals. Thus a less expensive type of transmission line 138 can be used in lieu of the prior art high isolation lines. Any other filter types of filters, high and low pass, band reject, cavity, etc., can be used as the filter 132 in FIG. 10.

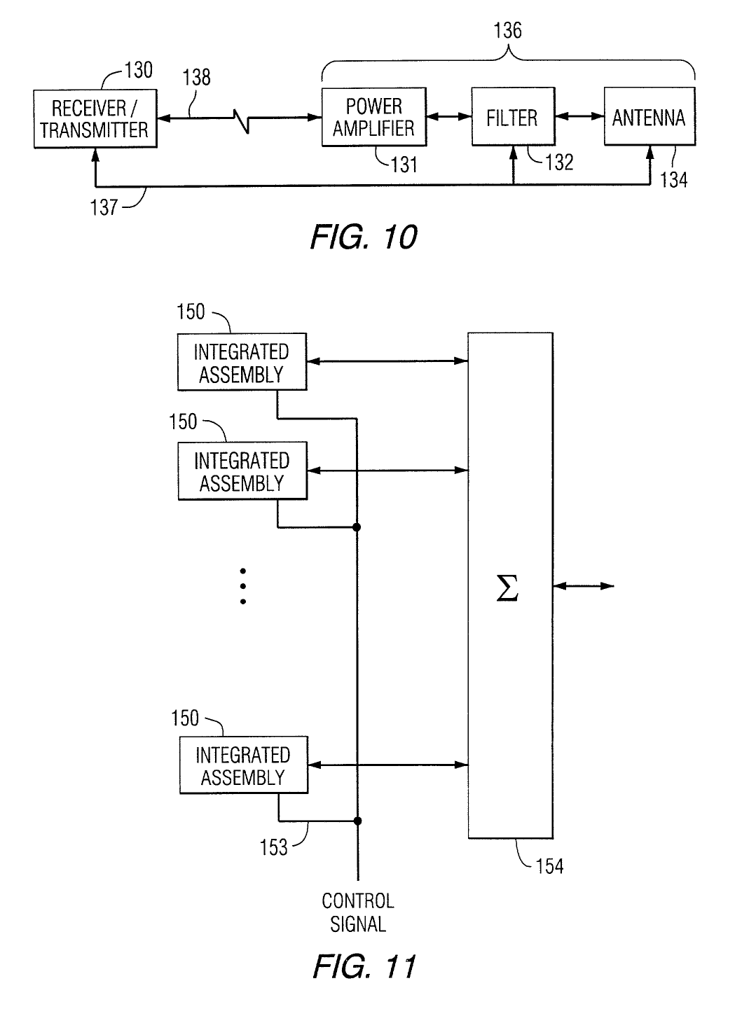

One application for the teachings of the present invention applies the integrated assembly 136 to the antenna array 100 of FIG. 8 or the antenna array 110 of FIG. 9, by locating the integrated assembly 136 in the cylinder 102. The filter 132 of the integrated assembly 136 can be of the analog or digital type and further can applied to one or more individual elements of the array antenna, such as one or more of the meanderline loaded antennas 10 of FIG. 8, or to one or more of the horizontally oriented elements 112 and the vertically oriented elements 114 of FIG. 9.

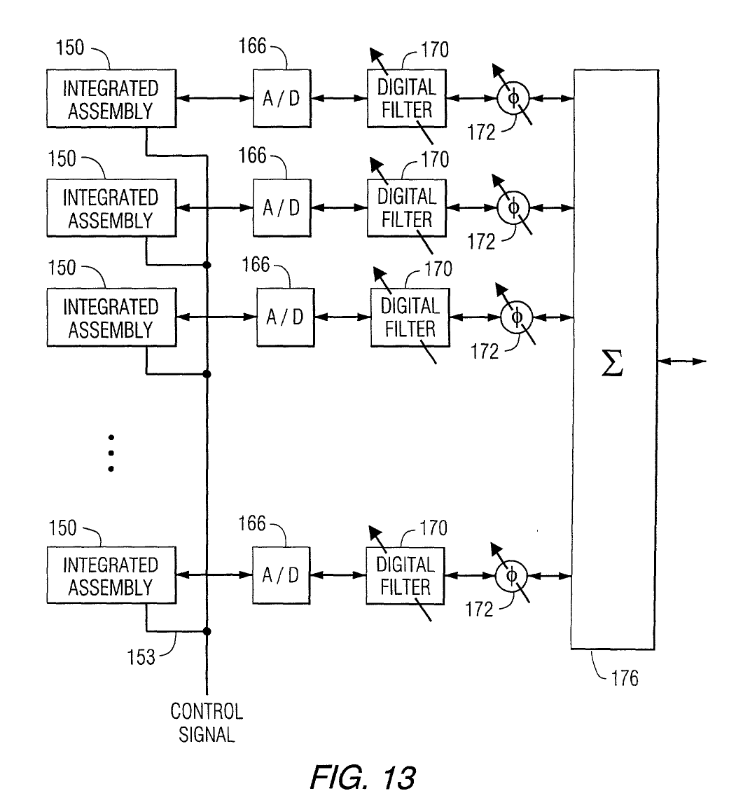

For example, as shown in FIG. 11, an integrated assembly 150 comprises the integrated assembly 136, where the antenna 134 comprises a meanderline loaded antenna as described above. The integrated assemblies 150 are responsive to a summer or combiner 154. In this embodiment, each filter 132 in an integrated assembly 150 can be designed with a specific filter characteristics based on the interference to which its associated meanderline loaded antenna is exposed. The filtering characteristics of each filter 132 are also dynamically and adaptively controllable by a control signal on a control line 153.

Alternatively, as illustrated in FIG. 12, each meanderline loaded antenna 10 is directly responsive to the summer 154 at a first plurality of terminals, and the filter and the power amplifier functions, as represented by the integrated assembly 156 are responsive to the summer 154 at a second terminal. In both the FIG. 11 and FIG. 12 embodiments, the integrated assembly 150 and 156 are located within the cylinder 102.

FIG. 13 illustrates an adaptive or smart antenna embodiment of the present invention as applied to either the antenna array 100 or 110. These embodiments showing meanderline loaded antennas are merely exemplary as the teachings of the present invention can be applied to any antenna type in an array or operative individually. The integrated assembly 150 of FIG. 13 comprises the integrated assembly 136, wherein the antenna 134 comprises a meanderline loaded antenna 10. Each of the filters 132 within the integrated assemblies 150 are not required to have the same frequency response characteristics. Each can be uniquely designed in conjunction with the desired characteristics of the integrated antenna element/filter. In this digital embodiment, in the receiving mode the integrated assembly 150 provide an input signal to analog-to-digital converters 166, for converting the analog received signal to a digital signal. The analog-to-digital converts 166 provide an input signal to a digitaldomain filter 170, for example, the digital domain filter comprises a finite-duration impulse response or an infinite-duration impulse response filter. In this array embodiment, the signal received from each meanderline loaded antenna 10 is phase shifted by the corresponding controllable phase shifter 172. The phase shifted signals are combined in a summer 176. As an alternative to locating the digital filters as shown in FIG. 13, a single filter can be located downstream (in the receiving mode) of the summer 176. In either case, the integrated assemblies 150, the analog-to-digital converters 166, the digital filters 170 and the phase shifters 172 are located within the cylinder 102 of the FIG. 8 and 9 antenna arrays. Thus in the embodiment of FIG. 13, a control processor (not shown in the figure) independently controls the parameters of the digital filters 170 and the phase shifters 172 to select or reject a particular signal by simultaneous beamforming (i.e., by controlling the weight applied to the phase shifters 172) and frequency selection/rejection (i.e., by controlling the characteristics of the digital filters 170 and/or the characteristics of the filter 132 within the integrated assembly 150). For example, an antenna pattern spatial null can be created by appropriate adjustment of the phase shifter weights while simultaneously forming a frequency spectrum null by way of the controllable digital filters 170 and the filters 132.

It is known that an antenna inherently provides a filtering function due to its limited performance bandwidth. Thus in the embodiments described above, the integrated assembly inherently includes the filtering function as determined by the antenna, plus the additional filtering provided by the cooperating filter, either analog or digital. Certain antennas are dynamically tunable, such as a hula hoop antenna. The capacitance between the two terminals of the hula hoop is controllable by placing a variable capacitor across the terminals, Thus the antenna is tunable and thereby provides a tunable filtering function. Further, frequency selective antennas can be dynamically tuned to enhance the selectivity of the antenna against nearby in-band interfering signals. Likewise, the filter associated with the antenna element, as taught by the present invention, can also be made tunable by the inclusion of tunable components that change the resonant frequency and/or the bandwidth of the filter.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth herein. In addition, modifications may be made to adapt a particular situation to the teachings of the present invention without departing from its essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for receiving radio frequency signals when operative in a receiving mode and for transmitting radio frequency signals when operative in a transmitting mode, said apparatus comprising:
a signal receiver;
a signal transmitter;
a transmission line having a first end switchably connected to said signal transmitter and said signal receiver;
a filter electrically connected to the second end of said transmission line; and an antenna located proximate said filter and responsive thereto, said antenna for transmitting the signal in the transmitting mode and for receiving the signal in the receiving mode.

2. The apparatus of claim 1 wherein the transmission line provides relatively high isolation to external radio frequency signals.

3. The apparatus of claim 1 wherein the transmission line is a fiber optic cable.

4. The apparatus of claim 1 further comprising a mast, wherein the filter and the antenna are located in the upper region of said mast.

5. The apparatus of claim 4 wherein the signal receiver and the signal transmitter are located at the base of the mast.

6. The apparatus of claim 1 wherein the filter is selected from the group comprising a band pass filter, a band reject filter, a notch reject filter, a low pass filter, a high pass filter, a duplexer and a diplexer.

7. The apparatus of claim 1 further comprising a controller, wherein the filter is responsive to said controller for changing the filter characteristics.

8. The apparatus of claim 7 wherein the filter characteristics include, the filter pass band, the filter center frequency and the filter skirts.

9. The apparatus of claim 1 further comprising a power amplifier disposed between the second end of the transmission line and the filter.

10. The apparatus of claim 9 wherein a relatively low power signal is provided by the transmitter to the transmission line.

11. The apparatus of claim 1 further comprising a power amplifier disposed between the filter and the antenna.

12. The apparatus of claim 11 wherein a relatively low power signal is provided by the transmitter to the transmission line.

13. An apparatus for transmitting radio frequency signals comprising:
a signal transmitter;
a transmission line responsive to said signal transmitter;
a filter responsive to said transmission line; and
an antenna located proximate said filter and responsive thereto, said antenna for transmitting the radio frequency signals.

14. The apparatus of claim 13 wherein the transmission line is a fiber optic cable.

15. The apparatus of claim 13 further comprising a power amplifier disposed between the transmission line and the filter and located proximate the filter.

16. The apparatus of claim 13 further comprising a power amplifier disposed between the filter and the antenna.

17. An antenna array comprising a plurality of antenna elements for receiving radio frequency signals when operative in a receiving mode and for transmitting radio frequency signals when operative in a transmitting mode, said apparatus comprising:
a signal receiver;
a signal transmitter;
a signal summer having a first terminal and a plurality of second terminals;
a transmission line having a first end switchably connected to said signal receiver and said signal transmitter and a second end electrically connected to the first terminal of said signal summer; and
a plurality of integrated antenna elements, wherein each one of said plurality of integrated antenna elements is electrically connected to one of the like plurality of second terminals of said summer.

18. The antenna array of claim 17 wherein each one of the plurality of integrated elements comprises an antenna element for receiving radio frequency signals when operative in a receiving mode and for transmitting radio frequency signals when operative in a transmitting mode, and a signal filter collocated with said antenna element.

19. The antenna array of claim 18 wherein the antenna comprises a meanderline loaded antenna.

20. The antenna array of claim 18 wherein the signal filter characteristics are controllable in response to a control signal input to the signal filter.

21. The antenna array of claim 17 wherein each one of the plurality of integrated elements comprises an antenna element for receiving radio frequency signals when operative in a receiving mode and for transmitting radio frequency signals when operative in a transmitting mode, a signal filter collocated with said antenna element, and a power amplifier collocated with said antenna element.

22. The antenna array of claim 20 wherein the antenna comprises a meanderline loaded antenna.

23. The antenna array of claim 21 wherein the signal filter characteristics are controllable in response to a control signal input to the signal filter.

24. The antenna array of claim 17 wherein the transmission line comprises a fiber optic cable.

25. The antenna array of claim 17 wherein each one of the plurality of integrated elements comprises an antenna element for receiving radio frequency signals when operative in a receiving mode and for transmitting radio frequency signals when operative in a transmitting mode, a signal filter collocated with said antenna element, and a signal weight for controlling at least one of the phase and the amplitude of the signal provided by the antenna element in the receiving mode and for controlling at least one of the phase and the amplitude of the signal transmitted by the antenna element in the transmitting mode.

26. The antenna array of claim 25 further comprising a controller for controlling the characteristics of the signal filter, such that the antenna array is spatially and frequency controllable.
